(19) United States
(12) Patent Application Publication
(10) Pub. No.: US 2012/0159625 A1
(43) Pub. Date: Jun. 21, 2012

(54) MALICIOUS CODE DETECTION AND CLASSIFICATION SYSTEM USING STRING COMPARISON AND METHOD THEREOF

(75) Inventors: Hyun-Cheol JEONG, Seoul (KR); Seung-Goo JI, Seoul (KR); Tai Jin LEE, Seoul (KR); Jong-Il JEONG, Seoul (KR); Hong-Koo KANG, Seoul (KR); Byung-Ik KIM, Seoul (KR)

(73) Assignee: KOREA INTERNET & SECURITY AGENCY, Seoul (KR)

(21) Appl. No.: 13/282,978

(22) Filed: Oct. 27, 2011

(30) Foreign Application Priority Data
Dec. 21, 2010 (KR) 10-2010-131401

(51) Int. Cl. G06F 21/24

(52) U.S. Cl. 726/23

(57) ABSTRACT

The present invention provides a malicious code detection and classification system using a string comparison technique, including a string extracting unit configured to extract all expressed strings existing in a binary file from the malicious code binary file; a string refining unit configured to refine elements obstructing malicious code detection and classification in the strings extracted from the string extracting unit; and a string comparison unit configured to determine how similar one binary is to another binary by comparing strings refined from the string refining unit.

### RELATED APPLICATION

Pursuant to 35 U.S.C. §119(a), this application claims the benefit of Korean Application No. 10-2010-131401, filed on Dec. 21, 2010, the contents of which is hereby incorporated by reference herein in its entirety.

### BACKGROUND OF THE INVENTION

1. Field of the Invention

The present invention relates to a malicious code detection and classification system using a string comparison technique and method thereof, and more particularly, to a malicious code detection and classification system using a string comparison technique and method thereof for proposing a static analysis technique to support malicious code detection and classification by measuring the similarity between two execution files through string comparison.

2. Description of the Related Art

In recent several years, the number of malicious codes has been greatly increased.

According to the Symantec Internet Security Threat Report, over 2.8 million new malicious code signatures were created in 2009 alone, which was a value increased by 71% compared to last year. Furthermore, the number represents 51% of all malicious code signatures that have been created until now. To deal with explosively increasing malicious codes, the training of specialists training would be important but the automation of an analysis system would be also indispensable.

A malicious code analysis system may be largely divided into a method using a dynamic analysis and a method using a static analysis. The dynamic analysis may be carried out on a file to obtain information on what action an analysis object takes and what effect it has thereon. It helps to determine whether or not any malicious code is detected as well as the action characteristic of an analysis object. On the contrary, the static analysis may be carried out without performing a file, and thus there exist numerous restrictions in applying to an analysis system. Nevertheless, the static analysis has an advantage capable of determining whether or not there exists any specific malicious code variant by comparing with malicious codes that have been analyzed.

Among representative malicious code static analysis methods, there is a method of analyzing a code region of one execution file to illustrate the break points of a program as a graph. The malicious code analysis using a control flow graph (CFG) may be suitable to automate the similarity verification between two execution files. Similarly, a method of verifying the similarity between two execution files by comparing strings extracted from the execution files may be also sufficiently effective in a malicious code automatic analysis system. In particular, the former method cannot be used for execution files containing an element obstructing a disassemble function or an obfuscation function, and therefore, studies on a static analysis technique having a high general purpose property as in the latter would be required.

### SUMMARY OF THE INVENTION

Accordingly, the present invention is to solve the foregoing problems in the related art, and an object of the present invention is to provide a malicious code detection and classification system using a string comparison technique and method thereof in which the refining process for refining strings is applied thereto because the performance is determined according to the number and kind of compared strings, thereby enhancing the performance of the malicious code detection and classification system.

Furthermore, another object of the present invention is to provide a malicious code detection and classification system using a string comparison technique and method thereof in which the similarity between strings is measured instead of finding the same string, and the characteristics of strings included in malicious codes are taken into consideration in measuring the similarity to derive a more accurate result.

In order to accomplish the foregoing object, according to the present invention, there is provided a malicious code detection and classification system using a string comparison technique, and the system may include a string extracting unit configured to extract all expressed strings existing in a binary file from the malicious code binary file; a string refining unit configured to refine elements obstructing malicious code detection and classification in the strings extracted from the string extracting unit; and a string comparison unit configured to determine how similar one binary is to another binary by comparing strings refined from the string refining unit.

In this case, the binary data of the string may be data having continuous character region data defined in the ASCII or Unicode standard.

Furthermore, the strings extracted from the string extracting unit may be classified into all strings having less than or equal to 10 characters, meaningless strings having more than or equal to 10 characters, Windows DLL file and API names, library function names supported by a program language, and strings basically included in a PE file format.

In order to accomplish the foregoing object, according to the present invention, there is provided a malicious code detection and classification method using a string comparison technique, and the method may include extracting all expressed strings existing in a binary file from the malicious code binary file by a string extracting unit; refining elements obstructing malicious code detection and classification in the extracted strings by a string refining unit; comparing the refined strings by a string comparison unit; and determining how similar a string binary compared by the string comparison unit is to another binary.

Furthermore, in the step of refining elements obstructing malicious code detection and classification in the extracted strings by a string refining unit, the relevant string may be removed when the character combination of a string satisfies the following string refining equation.

IF (special characters+numerals>lowercase characters+uppercase characters)
Remove selected strings

ELSE
Store selected strings

Furthermore, in the step of comparing the refined strings by a string comparison unit, the string comparison unit may compare strings using a method of measuring the number of the same strings between two string sets.

Furthermore, in the step of comparing the refined strings by a string comparison unit, the string comparison unit may compare strings using a method of measuring the number of strings showing an edit distance value greater than or equal to a predetermined threshold value between two string sets.

Furthermore, in the step of determining how similar a string binary compared by the string comparison unit is to another binary, a Levenshtein distance value between two strings may be calculated and then the similarity may be rated based on a result of the following equation.

dj=½*(m/[S1]+m/[S2])

dw=dj+0.1*4(1−dj)

S1, S2=strings

m=total number of characters corresponding between S1 and S2

Furthermore, the similarity rating may be expressed from the minimum 0 to the maximum 1, and two strings may be determined to have the similarity as being close to 1.

Furthermore, in the step of determining how similar a string binary compared by the string comparison unit is to another binary, the determination of URL similarity may be carried out by selecting a string containing essentially inserted characters at the time of transmitting URL, and then determining the string similarity to a compared string set.

In this case, the essentially inserted characters at the time of transmitting URL may be http://, GET, POST, and the like.

As described above, according to the present invention, the refining process for refining strings may be applied thereto because the performance is determined according to the number and kind of compared strings, thereby having the effect of enhancing the performance of the malicious code detection and classification system.

Furthermore, according to the present invention, the characteristics of strings included in malicious codes may be taken into consideration in measuring the similarity by measuring the similarity between strings instead of finding the same string, and thereby having the effect of deriving a more accurate result.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a view illustrating a malicious code detection and classification system using a string comparison technique and process thereof according to an embodiment of the present invention;

FIG. 2 is a flow chart illustrating a malicious code detection and classification method using a string comparison technique according to an embodiment of the present invention; and

FIG. 3 is a graph illustrating a result when a malicious code Asylum is input to a malicious code detection and classification system using a string comparison technique employed in an embodiment of the present invention.

### DETAILED DESCRIPTION OF THE INVENTION

The working effect including the technical structure of a malicious code detection and classification system using a string comparison technique and method thereof will definitely be understood by those skilled in the art from the following detailed description with reference to the accompanying drawings illustrating an embodiment of the present invention.

Malicious Code Detection and Classification System Using String Comparison Technique

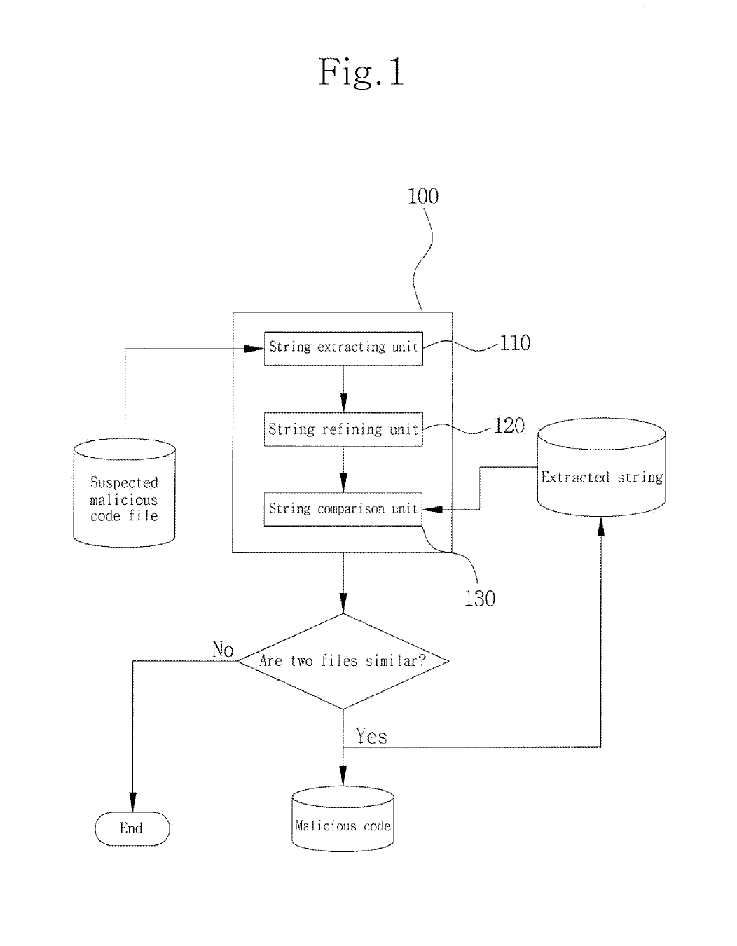

Referring to FIG. 1, a malicious code detection and classification system 100 according to the present invention may include a string extracting unit 110 configured to extract all expressed strings existing in a binary file from the malicious code binary file, a string refining unit 120 configured to refine elements obstructing malicious code detection and classification in the strings extracted from the string extracting unit 110, and a string comparison unit 130 configured to determine how similar one binary is to another binary by comparing strings refined from the string refining unit 120.

Here, the malicious code detection and classification system 100 using a string comparison technique is a system 100 for taking out all extractable strings from a binary file and then comparing the strings, respectively, to determine the similarity between two files. For example, if the similarity between two files is very high and one of them is a malicious code that has been previously analyzed, then the other one may be highly likely to be a variant of the malicious code. In other words, it is a system 100 for determining whether a newly received suspicious binary file is malicious and its variant information by using a malicious code that has been previously analyzed as a comparison reference.

The foregoing system 100 may largely include three constituent elements such as a string extracting unit 110, a string refining unit 120, and a string comparison unit 130.

The string extracting unit 110 may extract all expressible strings existing in a binary form. In this case, the binary data of the string may be determined as data having continuous character region data defined in the ASCII or Unicode standard. Typically, strings may have a null value as a terminator, but it is not always applicable in case of a string existing in execution files, and thus should be considered as continuous character region data without being terminated by 0x00. Malicious codes that have been an issue in recent years are most actively working in countries such as China, Brazil, India, and the like, except U.S.A., and therefore, it would be a good method to include a unique character region of the relevant country in the string extraction criteria.

The strings extracted from the string extracting unit 110 may be classified into all strings having less than or equal to 10 characters, meaningless strings having more than or equal to 10 characters, Windows DLL file and API names, library function names supported by a program language, and strings basically included in a PE file format as illustrated in the following Table 1. It illustrates numerical values for all strings extracted from 100 malicious codes selected for the experiment. The classified strings may be refined through the string refining unit 120 which will be described later, and the detailed description thereof will be made below.

TABLE 1

| String classification criteria | Distribution ratio | No. of strings |
|---|---|---|
| Strings having less than or equal | 83% | 86084 |
| to 10 characters | | |
| Windows DLL file and API names | 4% | 4509 |
| Subordinate function groups to a | 25 | 2609 |
| program language | | |
| Basic strings in a PE file format | 0.09% | 103 |
| Other strings | 10.91% | 10464 |
| Total | 100% | 13769 |

The string refining unit 120 may refine elements obstructing malicious code detection and classification in the extracted strings. A period of time consumed to compare strings may increase as increasing the number of strings extracted from a binary. Since the system performance should be necessarily considered in case of the system 100 of automatically analyzing a lot of malicious codes, the process of reducing the number of extracted strings may be essentially required. Furthermore, in case of strings that can be easily found not only in malicious codes but also in general execution files, they may reduce a hit rate of malicious code detection and classification, and that sort of strings should be preferably removed.

The string comparison unit 130 allows a process of determining how similar one binary is to another binary by comparing strings that have been subject to the refining process. The similarity between two files can be measured by basically grasping how many strings correspond with each other. Additionally, if an edit distance of each string is greater than or equal to a threshold value even though the strings do not correspond with each other, they may be treated as the same string as one another. It may be taken into consideration that the host or variable scope of a URL string or the like included in malicious codes can be frequently changed and redistributed.

Malicious Code Detection and Classification Method Using String Comparison Technique

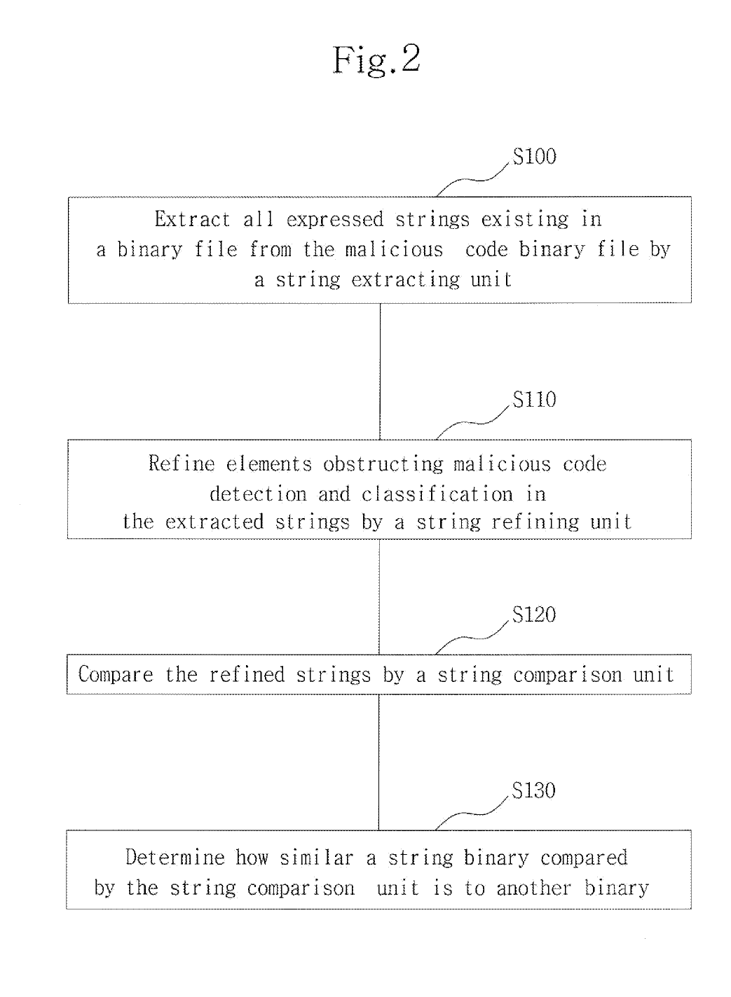

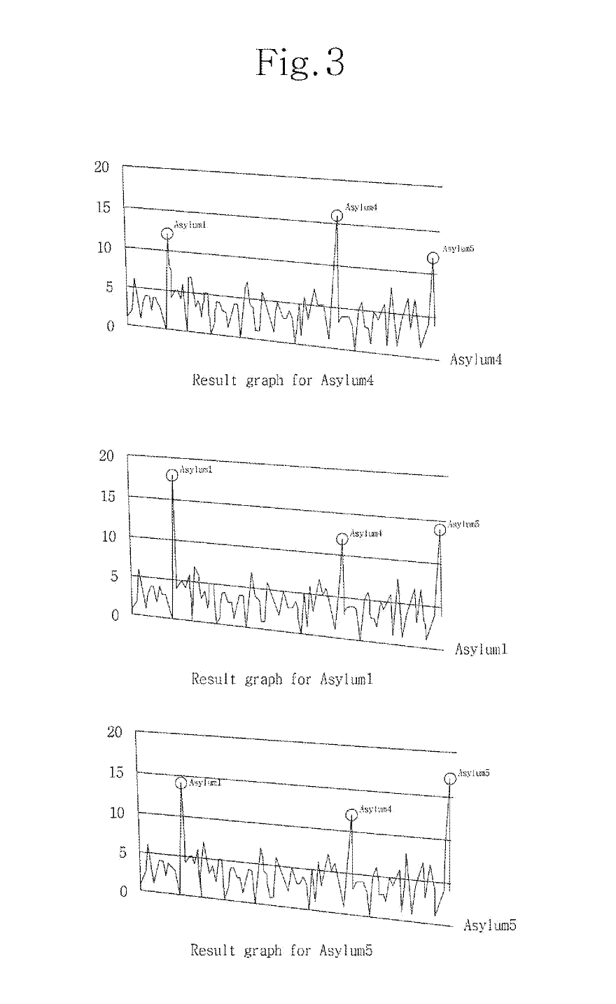

Referring to FIGS. 2 and 3, a malicious code detection and classification method using a string comparison technique according to an embodiment of the present invention is a detection and classification method based on a malicious code detection and classification system 100 using a string comparison technique having the foregoing configuration illustrated in FIG. 1 as described above, and the redundant description thereof will be omitted.

First, all expressed strings existing in a binary file may be extracted from the malicious code binary file by the string extracting unit 110 (S100).

Next, elements obstructing malicious code detection and classification in the extracted strings by the string refining unit 120 may be refined (S110). Strings may be extracted from one hundred malicious codes selected for the experiment through the string extracting unit 110 and then their distribution may be analyzed and as a result, elements having an effect on the performance of the malicious code detection and classification system 100 can be classified. The strings may be classified into all strings having less than or equal to 10 characters, meaningless strings having more than or equal to 10 characters, Windows DLL file and API names, library function names supported by a program language, and strings basically included in a PE file format.

Strings having less than or equal to 10 characters occupy most of the strings extracted from execution files as illustrated in Table 1. The string set may include a meaningless string consisted of special characters, numerals, and the like, and a meaningful but very short string. However, the meaningful strings may be ignored because they occupy less than 10% compared to the remaining strings in the distribution chart. It is because the edit distance result is not likely reliable when they are short strings. Furthermore, one of the reasons is that the refining condition may become complicated.

Meaningless strings having a combination of repeated special characters and numerals may be also shown in the strings having more than or equal to 10 characters. The meaningless strings may be small in number but it may be preferable to refine them if possible. If the character combination of a string satisfies the following string refining equation, then the relevant string may be removed.

IF (special characters + numerals > lowercase characters + uppercase
characters)

Remove selected strings

ELSE

Store selected strings

The portable executable (PE) file format may include a DLL file name and an API function name defined in a file to load a dynamic library to the memory when executing the file. Accordingly, if strings are extracted from the execution file, then a lot of DLL file names and Windows API function names may be outputted. All DLL file names and function names excluding rare Windows API function names, which are not typically used in the execution file having two elements, should be removed.

Malicious codes can be prepared in various languages to be generated by using various compilers. Typically, malicious codes may be prepared in C or C++ but sometimes they may be written in a language such as Delphi or Visual Basic (VB) to hinder reverse engineering. In this case, if a malicious code is written using a library function provided by each language, then finally the names of those functions may be written in the execution file. In particular, since Visual Basic is a programming language in the component type, the kinds of functions used for typical execution files or malicious codes may be not quite different. Accordingly, the removal should be taken into consideration for strings starting with “_vba” or having a prefix “_adj”.

Here, the PE is an execution file format of Windows operating system.

When a file is carried out in a Windows operating system, the file should have a PE structure regardless of whether or not it is a malicious code. Strings such as “!This program cannot be run in DOS mode,” “!This program must be run under Win32” or the like existing at the beginning of the PE header should be removed.

Next, the refined strings may be compared with one other by the string comparison unit 130 (S120). At this time, for a string comparison method used, the string comparison unit 130 may use a method of measuring the number of the same strings between two string sets as well as a method of measuring the number of strings showing an edit distance value greater than or equal to a predetermined threshold value between two string sets.

The existing string data may be maintained in a variant malicious code as it is unless resource area data in a PE execution file is directly modified. Due to this, it may be essentially required to have a process for checking whether or not there exists the same string in malicious code detection and classification. The more they have the number of the same strings between two string sets, the higher similarity they have, and as a result the system 100 may determine it as a their variant. However, malicious code detection through such a string comparison has a drawback in which the malicious code maker can elude detection even by investing a little time.

However, the handling of URLs used by malicious codes to transmit and receive data may be troublesome unlike that of typical strings. It is because that the server program itself should be modified to change the names or types of parameters transmitted for dynamic communication with the host. Accordingly, it may be possible to deal with more intelligent variant malicious codes by selecting only a string containing essentially inserted characters such as http://, GET, POST, and the like at the time of transmitting URL, and then measuring the string similarity to a compared string set.

Next, how similar one string binary compared by the string comparison unit 130 is to another binary may be determined (S130). In this case, a string similarity measurement method used may be as follows. First, a Levenshtein distance value between two strings may be calculated and then the similarity may be rated by using the following modified Jaro-Winkler equation based on the result. The similarity rating may be expressed from the minimum 0 to the maximum 1, and two strings may be determined to have the similarity as being close to 1.

dj=½*(m/[S1]+m/[S2])

dw=dj+0.1*4(1−dj)

S1, S2=strings

m=total number of characters corresponding between S1 and S2

One hundred test groups were organized from ten thousand malicious codes that have been previously analyzed to measure the performance of a malicious code detection and classification system 100 and method thereof through the foregoing string comparison technique. Of them, a malicious code selected as an input value of the system 100 was Backdoor.Wind32.Asylum and total five variants were included in the experiment. The classification names of the selected Asylums are illustrated in the following Table 2.

TABLE 2

| | Classification(Kaspersky) | Submission date |
|---|---|---|
| Asylum1 | Backdoor.Win32.Asylum.013.c | 2009-12-02 00:44:34(UTC) |
| Asylum2 | Backdoor.Win32.Asylum.Web.c | 2009-12-19 16:12:20(UTC) |
| Asylum3 | Backdoor.Win32.Asylum.Web.a | 2010-02-15 01:48:20(UTC) |
| Asylum4 | Backdoor.Win32.Asylum.012 | 2010-01-18 14:47:00(UTC) |
| Asylum5 | Backdoor.Win32.Asylum.013.e | 2009-12-23 02:34:45(UTC) |

The classification name in Table 2 follows the one of Kaspersky Lab, and the submission date means a date written in virus total.

FIG. 3 is a result graph when malicious codes Asylum4, Asylum1, Asylum5 are sequentially entered to the malicious code detection and classification system 100 through a string comparison technique. The horizontal axis of the graph represents one hundred malicious codes used for the experiment and the vertical axis thereof represents an output value of the system 100 (similar when the value is high). According to those graphs, it can be confirmed that Asylum1, Asylum4, and Asylum5 are similar to one another. On the contrary, it is shown that Asylum2, and Asylum3 are not similar to each other, and it is rather a correct result. As illustrated in Table 2, it is because that Asylum2 and Asylum3 are different type variants from Asylum1, Asylum4, and Asylum5, which have the classification name called Web even among the variants thereof.

As described above, according to a malicious code detection and classification system 100 using a string comparison technique and method thereof, the refining process for refining strings may be applied thereto because the performance is determined according to the number and kind of compared strings, thereby enhancing the performance of the malicious code detection and classification system 100, and the characteristics of strings included in malicious codes may be taken into consideration in measuring the similarity by measuring the similarity between strings instead of finding the same string, thereby deriving a more accurate result.

What is claimed is:

1. A malicious code detection and classification system using a string comparison technique, the system comprising:
a string extracting unit configured to extract all expressed strings existing in a binary file from the malicious code binary file;
a string refining unit configured to refine elements obstructing malicious code detection and classification in the strings extracted from the string extracting unit; and
a string comparison unit configured to determine how similar one binary is to another binary by comparing strings refined from the string refining unit.

2. The system of claim 1, wherein the binary data of the string is data having continuous character region data defined in the ASCII or Unicode standard.

3. The system of claim 1, wherein the strings extracted from the string extracting unit are classified into all strings having less than or equal to 10 characters, meaningless strings having more than or equal to 10 characters, Windows DLL file and API names, library function names supported by a program language, and strings basically included in a PE file format.

4. A malicious code detection and classification method using a string comparison technique, the method comprising:
extracting all expressed strings existing in a binary file from the malicious code binary file by a string extracting unit;
refining elements obstructing malicious code detection and classification in the extracted strings by a string refining unit;
comparing the refined strings by a string comparison unit; and
determining how similar a string binary compared by the string comparison unit is to another binary.

5. The method of claim 4, wherein in the step of refining elements obstructing malicious code detection and classification in the extracted strings by a string refining unit,
the relevant string is removed when the character combination of a string satisfies the following string refining equation.
IF (special characters + numerals > lowercase characters + uppercase
characters)
Remove selected strings
ELSE
Store selected strings

6. The method of claim 4, wherein in the step of comparing the refined strings by a string comparison unit,
the string comparison unit compares strings using a method of measuring the number of the same strings between two string sets.

7. The method of claim 4, wherein in the step of comparing the refined strings by a string comparison unit,
the string comparison unit compares strings using a method of measuring the number of strings showing an edit distance value greater than or equal to a predetermined threshold value between two string sets.

8. The method of claim 4, wherein in the step of determining how similar a string binary compared by the string comparison unit is to another binary,
a Levenshtein distance value between two strings is calculated and then the similarity is rated based on a result of the following equation.
dj=½*(m/[S1]+m/[S2])
dw=dj+0.1*4(1−dj)
S1, S2=strings
m=total number of characters corresponding between S1 and S2

9. The method of claim 8, wherein the similarity rating is expressed from the minimum 0 to the maximum 1, and two strings are determined to have the similarity as being close to 1.

10. The method of claim 4, wherein in the step of determining how similar a string binary compared by the string comparison unit is to another binary,
the determination of URL similarity is carried out by selecting a string containing essentially inserted characters at the time of transmitting URL, and then determining the string similarity to a compared string set.

11. The method of claim 10, wherein the essentially inserted characters at the time of transmitting URL are http://, GET, POST, and the like.
